(19) United States
(12) Patent Application Publication
(10) Pub. No.: US 2008/0002735 A1
(43) Pub. Date: Jan. 3, 2008

(54) DEVICE NETWORK

(75) Inventors: Jean-Francois POIRIER, Deux-Montagne (CA); Pascal TURCOTTE, Deux-Montagne (CA)

Correspondence Address: BERESKIN AND PARR, 40 KING STREET WEST, BOX 401, TORONTO, ON, M5H 3Y2, CA

(73) Assignee: PARADOX SECURITY SYSTEMS LTD., St-Eustache (CA)

(21) Appl. No.: 11/766,728

(22) Filed: Jun. 21, 2007

Related U.S. Application Data
(63) Continuation of application No. PCT/CA97/00206, filed on Apr. 1, 1997.

(51) Int. Cl. H04L 12/413

(52) U.S. Cl. 370/445

(57) ABSTRACT

The network uses detection of collision based on start bit transmission under poor transmission line conditions and with a large number of devices on the network. Data throughput is double that of CSMA-CA for the same network conditions. Some network devices operate with dual protocols. The network device has a network transceiver and a processor that uses an interrupt to detect transmission on the line for start bit detection.

### FIELD OF THE INVENTION

The present invention relates to local data network for devices, such as security systems, control systems and/or home automation systems, as well to network interface devices for such networks.

### BACKGROUND OF THE INVENTION

Device networks are used to connect a variety of electronic devices to be in communication. One example is a control network, such as an HVAC control network, home automation network, or a building access network. Data rates can be much lower than in Ethernet networks. In security systems, digital networks are commonly employed to interconnect devices to a control panel. In many applications, it is desirable to avoid expensive wiring. The cost of wiring is a result of installation and the actual cost of the cable. Ethernet cabling involving multiple twisted pair strands is often deemed to costly.

As a result of using untwisted or unshielded cabling, the transmission on the wires is often balanced, namely, each bit is transmitted by applying equal and opposite polarity signals on a pair of conductors. While the unshielded transmission line is more vulnerable to receiving noise from external sources, noise is easier to discriminate from signal by measuring the differential voltage between the wires, since noise is often of the same polarity on both wires.

Such simple cabling networks are able to handle medium bandwidths typically well above 100 kbs under certain circumstances. While this is much less than the ten megabit speed typical of Ethernet LAN cabling, it is generally sufficient for many control applications.

Likewise, a simple mesh topology may also be used instead of installing cabling in a loop or daisy chain since the latter requires installing extra lengths of cable. However, end-of-line (EOL) terminations are more difficult to select and locate in a mesh topology to avoid noise due to reflections, and maintain the desired medium bandwidth. EOL terminations are passive loads that reduce signal reflection on the transmission line. Without such terminations, reflections cause transmission errors and in combination with the signal distortion caused by the capacitance added by surge protection circuitry in the devices on the network, the bandwidth available is typically reduced, to about 1 kbs. The reduction in available bandwidth results from two sources. One is the distortion on the transmission line that makes the use of a lower signaling frequency necessary, and the other is collision in the case of asynchronous protocol networks with a large number of network devices.

Carrier sense multiple access (CSMA) is class of protocols according to which a station wishing to transmit has to first listen to the channel for a predetermined amount of time so as to check for any activity on the channel.

In pure CSMA, the network device transmits on the line if no one else is detected to be transmitting at the moment the device wants to begin transmitting. Essentially, collision is determined before sending the first bit, although collision can also be determined when the transmission fails to generate an appropriate acknowledgement from a recipient of the data.

In CSMA-CA, namely with collision avoidance, the protocols involve sending a first packet when the transmission line should be free. If the first packet is fully sent without another network device beginning its transmission, then the sender of the first packet uses exclusively the line for a number of further packets. Essentially, collision is determined after sending the first packet.

CSMA-CA is commonly used instead of pure CSMA since it prevents collision because all nodes are aware of a transmission before it occurs. Also collision avoidance is not dependent on rapid response detection of the start bit, and thus is easier to implement in microprocessor-based systems that take a number of clock cycles between sensing the transmission line or medium and actually transmitting a start bit.

If the channel is sensed “idle” then the station is permitted to transmit. If the channel is sensed as “busy” the station has to defer its transmission

EIA-485, also known as RS-485, is a transport medium specification for a two-wire, half-duplex, multipoint serial connection using balanced or differential signaling. RS-485 does not specify or recommend any data protocol, and is recognized as being suitable for inexpensive local networks and multidrop communications links. Of course, many other transport medium protocols can also be implemented for inexpensive local networks and multidrop communications links.

The chosen protocol may involve asynchronous communication and a simple packet structure. Collision occurs when two devices transmit data at the same time on the same channel. A device may decide to transmit only when there is quiet on the network transmission medium. While transmitting a packet, a device records what is received from the transmission medium, and if what is received is not the same as what was transmitted, the device determines that there was collision, and will retransmit the packet.

In many cases, RS-485 and simple protocols are used in applications in which a microcontroller or processor is responsible for transmission of a packet, and the time from detecting quiet on the network to the instant that packet transmission begins is great enough to significantly increase the opportunity for collision on the network. In other words, one device may detect quiet on the network and decide to transmit its data, and before it begins to do so, another device will detect quiet and decide to transmit its packet as well. This leads to collision, and in the case of such protocols using RS-485 in which collision detection is performed by analyzing what was received on the network following packet transmission, the time period of a packet is lost before data can be successfully transmitted. Collision can also be detected by not receiving an appropriate acknowledge signal from the destination of the packet.

### SUMMARY OF THE INVENTION

It has been discovered that when there are a large number of network devices and the network transmission line limits the minimum bit length such that the minimum time to transmit a packet having at least 8 bits of payload is significant due to poor line quality, as is the case with a multi-drop mesh topology, the use of pure CSMA instead of CSMA-CA or other branches of the CSMA family of protocols improves the nominal effective data transmission throughput on the network by a factor of two or more. In typical local networks, the line quality is good enough that the time to resolve collisions using CSMA-CA is not significant, and it then becomes better for collision avoidance than pure CSMA.

It has been discovered that a device network is possible that allows for mesh topology, no end-of-line (EOL) terminations, unshielded or untwisted pair cabling, and medium bandwidth. The inherent increase in line reflections and its impact on the effective bandwidth can be compensated by using improved data packet collision management in an asynchronous transmission protocol.

It has been discovered that a device network is possible that allows for mesh topology, no end-of-line (EOL) terminations, and unshielded or untwisted pair cabling, with a network dimension in terms of distance and number of nodes that is significantly greater than the prior art. This device network is achieved using network interfaces at the devices that use low capacitance surge protection circuits so that each node does not significantly load the transmission line.

It has been discovered that a device network is possible that allows for priority control data to be sent using a synchronous master-slave protocol while also allowing medium bandwidth data to be sent asynchronously on the same line. The asynchronous network interfaces can give priority to transmission of the master-slave protocol transmission. This hybrid protocol transmission allows for devices on the network to initiate transmission, a feature not available in a master-slave protocol where a device can only transmit on the line in response to a request from the master. Alternatively, it is possible to allow for asynchronous communications to take place within time windows established by the master's clock signal. This allows the master to communicate synchronously whenever it chooses, and also for other devices to communicate asynchronously.

According to a first object of the present invention, there is provided a method for preventing collision in a terminal device of a data network. The terminal device has a network transceiver and a processor having a first program to cause the processor to transmit a packet of data using the network transceiver in accordance with a data transmission protocol. The data transmission protocol is typically of the type that determines collision by detecting received data during transmission of a packet and by comparing transmitted data to received data following transmission of the packet. If the received data matches the transmitted data, there is no collision, and, if not there is collision. A second program in the processor listens to the data network via the network transceiver to determine, in accordance with the protocol, a time to transmit data. At this time, the first program begins transmission of a packet by sending data to a transmit signal input of the network transceiver in accordance with the protocol. At a circuit level associated with the network transceiver, a received signal in the transceiver is detected at a time of sending data to the transmit signal input. In response to this detection, transmission of the packet is prevented.

In some embodiments of the invention, the detecting and preventing comprise enabling an interrupt in the processor in response to detection of a received signal in the transceiver, wherein the interrupt stops the first program from transmitting when the detection of a received signal in the transceiver occurs before the transmission of the packet. Preferably, the processor responds to the interrupt by checking to see if the first program executed an instruction to begin sending data to the transceiver, and if not, the first program is stopped from sending data. Alternatively, circuitry may be used to disable the interrupt in response to the sending of data to the transmit signal input of the transceiver.

Given that the invention effectively prevents collision, the first program may time, in response to the interrupt, when transmission of the packet should have been completed and then immediately recommence transmission of the packet. This should be when the other terminal device finishes transmitting the packet. Such retransmission can be attempted without using the second program to determine time to transmit, since an error in the assumption that the terminal is free to transmit on the network will not cause collision in accordance with the invention.

According to a second object of the present invention, there is provided a method for network communications in a terminal device having a network transceiver and a processor operating to execute programs in a single tasking manner. The method comprises enabling a receive signal response interrupt in the processor in response to detection of a received signal in the transceiver. The receive signal response interrupt causes essentially immediate execution of a program in the processor to detect and decode an incoming packet. Preferably, the method further comprises causing the processor to enter a sleep mode in which no program instructions are executed, and the receive signal response interrupt causes the processor to exit the sleep mode.

According to a third object of the present invention, there is provided a method for network communications in a terminal device in which a width of a shortest bit of at least one packet received is measured to determine a baud rate for transmission on the network.

The invention is applicable to wired networks as well as wireless networks.

In some embodiments, there is provided a local network for interconnecting devices, such as building control and/or security system devices. The network has a transmission cable interconnecting a large number of network devices in a multi-drop, mesh topology without end-of-line terminations, and a large number of network devices connected to and communicating asynchronously on a transmission line of the cable using a packet size containing at least 7 data bits and pure CSMA. A combination of the number of network devices, a (poor) quality of the transmission line and the packet size results in a nominal effective data transmission throughput on the network of two or more times greater than the same nominal effective data transmission throughput on the network under conditions that collision detection is done after transmission of a first full packet by the devices on the network. In some embodiments, the nominal effective data transmission throughput on the network using pure CSMA or collision detection based on the start bit is actually better than 3 times than the nominal effective data transmission throughput on the network under conditions that collision detection is done after transmission of a first full packet by the devices on the network.

Surge protection circuitry is connected to most or all of the network devices, and the circuitry may have a capacitance less than 250 pF for each network device. In some embodiments, the surge protection capacitance is less than 60 pF. The network cable can be unshielded or untwisted, and the physical layer signaling on the transmission line can be differential or balanced.

The network devices may comprise a microcontroller for handling protocol layer communications on the network. In this case, the microcontroller has an interrupt connected to a received signal from the network and being configured to implement collision detection and avoidance at least up to transmission of a start bit. The microcontroller may also perform data processing for operation of the network devices.

The number of network devices may be greater than 64.

In some embodiments, there is provided a dual protocol network device comprising a master/slave protocol communications module connected to a network connection, a carrier sense multiple access protocol module connected to the network connection, and a microcontroller adapted to switch between the master/slave protocol communications module and the carrier sense multiple access protocol module for transmitting data on the network. The master/slave protocol may be used by a security system control panel acting as a master and a number of the network devices may perform intrusion detection functions acting as slaves. Some of the network devices may perform building control functions and communicate asynchronously using the carrier sense multiple access protocol module.

In some embodiments, the invention provides a local network pure CSMA device for building control and/or security systems. The network device has a microcontroller for handling protocol layer communications on the network, the microcontroller having an interrupt connected to a received signal from the network and being configured to implement collision detection and avoidance at least up to transmission of a start bit. The microcontroller may also perform data processing for building control and/or security system functions of the network device.

### BRIEF DESCRIPTION OF THE DRAWINGS

The invention will be better understood by way of the following detailed description of a preferred embodiment with reference to the appended drawing in which:

FIG. 1 is a block diagram of a terminal device in accordance with the preferred embodiment;

FIG. 2 is a block diagram illustrating program modules within said terminal device processor;

FIG. 3 is a network topology diagram;

FIG. 4 is a circuit diagram of a dual protocol security system control panel that acts as a master during synchronous communications; and

FIG. 5 is a circuit diagram of a dual protocol network device.

### DETAILED DESCRIPTION OF THE INVENTION

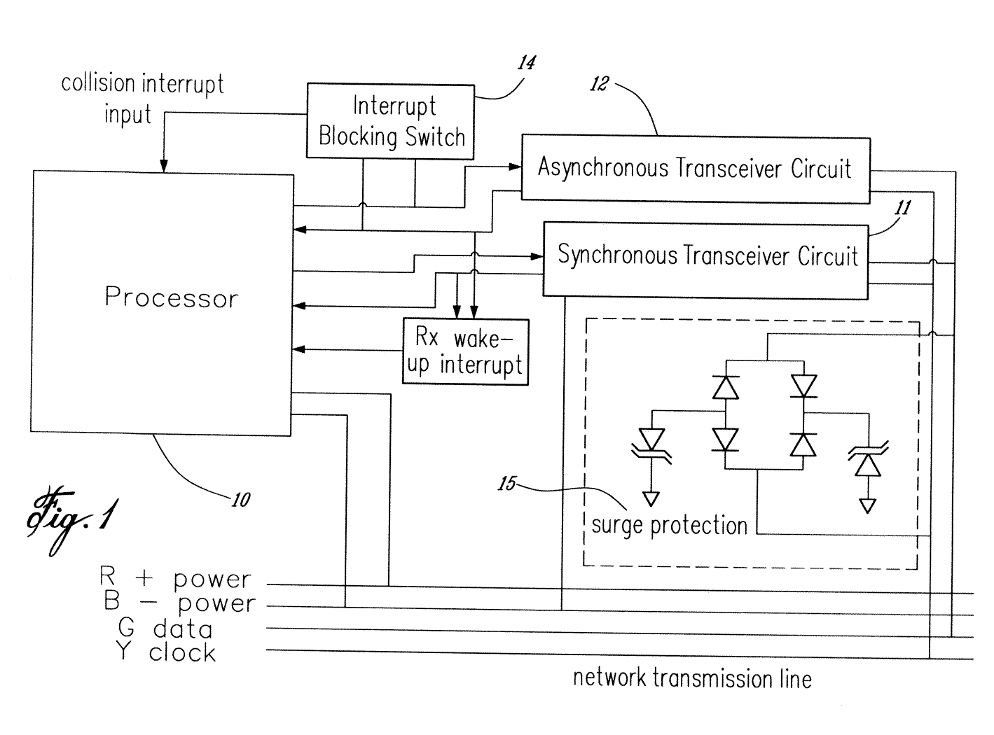

In the embodiment of FIG. 1, a network device is illustrated in which both synchronous and asynchronous communications are possible on the same network. The network transmission line is of the type that has four wires, two for power (namely the red and black) and two for transmission (namely green and yellow).

The synchronous transmission circuit 11 encodes/decodes a master-slave transmission protocol in which a single bit of data is transmitted on the data line timed by the clock signal. The master device sends the clock signal, and in one embodiment, the master sends one bit during each clock low. When a slave device is directed to transmit by the master, it sends its bits during each clock high until its data has been sent. In this way, data transmission is split between sending from the master and sending from the selected slave device.

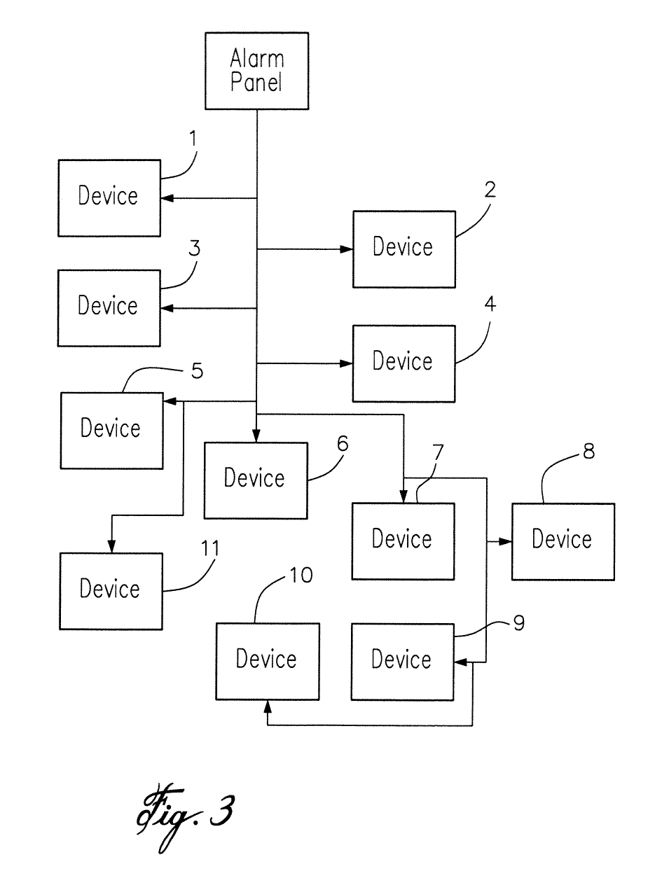

The synchronous transmission protocol can work efficiently with a mesh network topology as shown in FIG. 3 without end-of-line (EOL) terminations. This network topology and synchronous protocol is implemented in the Digiplex™ security system network sold by Paradox Security Systems, and to allow for conventional higher capacitance surge protection circuitry and for a total network length that can cover most residence and small business applications, the clock rate is set to a low value of 1 kHz. The master/slave protocol has proven itself to be reliable and safe for the low data rate application in security systems. To be backward compatible with the Digiplex™ network, the synchronous protocol used in combination with the asynchronous communications functionality may likewise have a 1 kHz clock.

Returning to FIG. 1, the circuit 11 is connected to ground or the negative power line, as the clock and data signals are compared with respect to ground. In the embodiment of FIG. 1, the device is operative to work with both synchronous and asynchronous communications on the same bus or transmission line. The synchronous transceiver 12 is connected to the data and clock lines and detects a balanced or differential signal between these lines.

A low capacitance surge protection circuit 15 is provided to protect the circuits 11 and 12. It will be appreciated that the use of a low capacitance surge protection circuit allows the number of devices able to be connected to the network to be significantly increased, since a conventional low-cost surge protection circuit using a varistor may have a capacitance well over 1300 pF, while the circuit shown has a capacitance of about 40 pF. Varistors exhibit high capacitance when designed to shunt at low voltages, namely under 32V, and in particular at 12V. As will be appreciated, the load of each conventional network device is mostly due to the surge protection circuit and not the transceiver circuitry itself. In the circuit illustrated, the transorb devices would normally add much greater capacitance, however, the addition of diodes in series with the transorb devices reduces the capacitance.

By choosing low capacitance and low cost surge protection circuits, the number of devices on the network can be increased to over 32. In fact, the mesh network illustrated in FIG. 3 can handle about 1000 m of length when operating at 12V with simple unshielded, untwisted cable of a gauge of about 22 AWG to 26 AWG, and without using any EOL terminations. Each device having such a low capacitance surge protection removes about 0.3 m of potential length to the network topology. In the asynchronous transmission mode, data transmission rates of about 70 to over 150 kbs are achieved with over 48 devices active on the mesh topology network. In fact, in one test configuration, a data rate of 76.8 kbs with 273 nodes was achieved on the network operating at 12V with simple unshielded, untwisted cable of a gauge of about 22 AWG to 26 AWG, and without using any EOL terminations. This result is the combination of using low capacitance surge protection and efficient collision avoidance in the network devices.

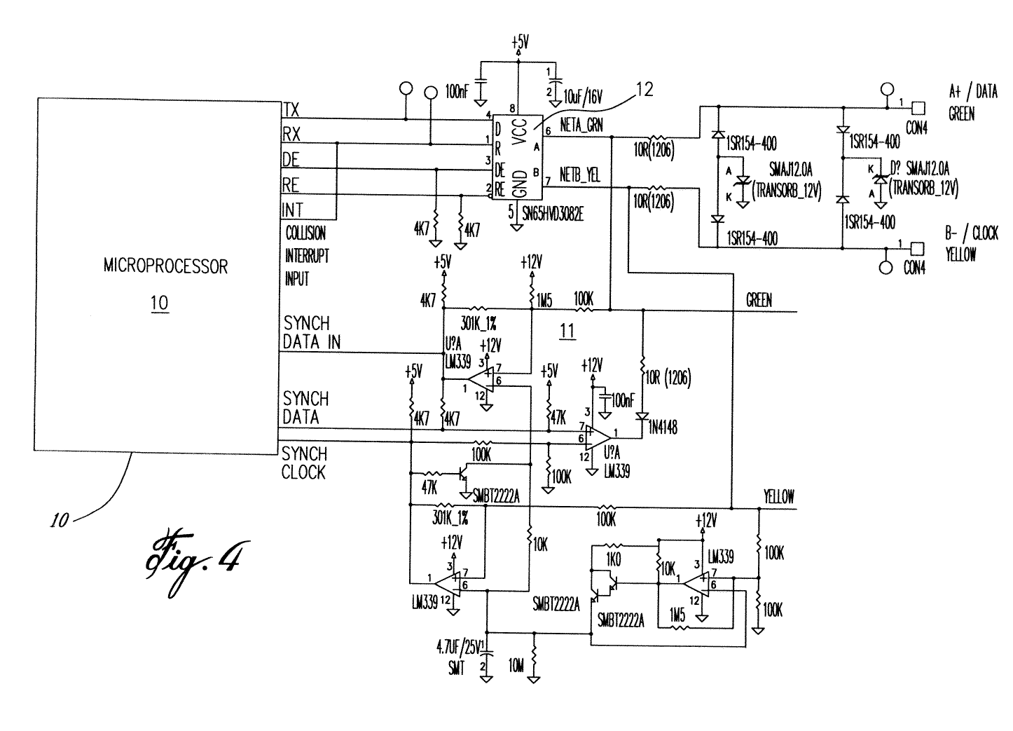

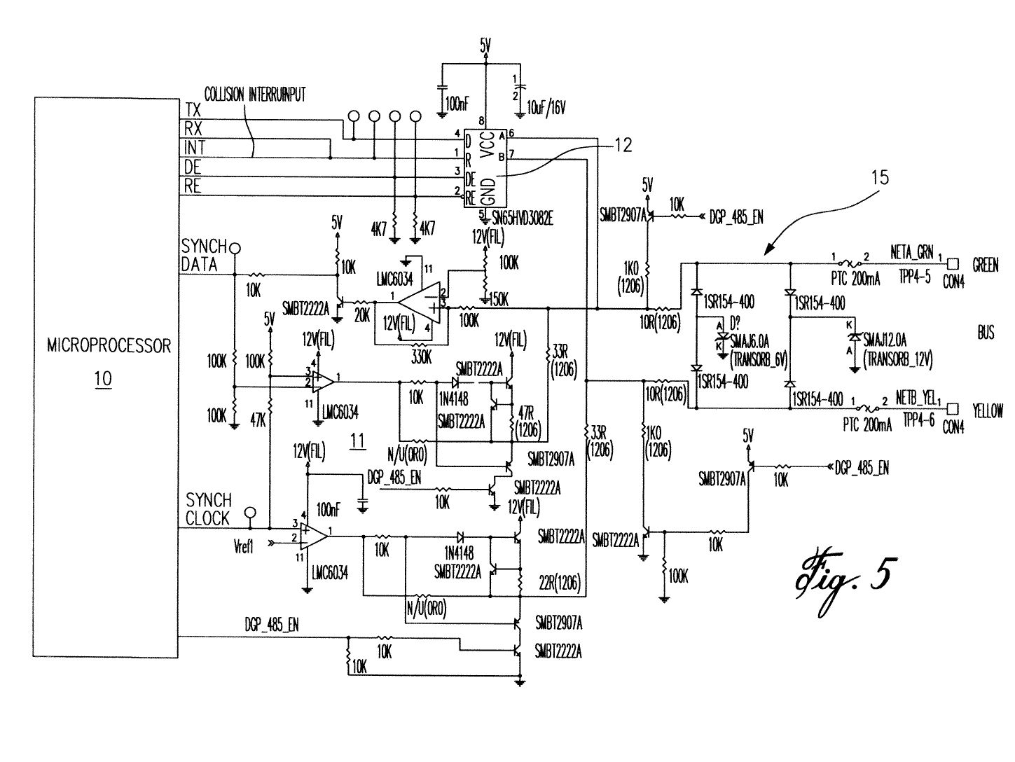

FIG. 4 shows a circuit diagram similar to the block diagram of FIG. 1 for the case of a security system control panel. The panel generates the clock signal on the network bus when desired. In FIG. 5, a circuit diagram similar to the block diagram of FIG. 1 is shown for the case of a network device that can communicate using the synchronous protocol with the control panel, or with any device using the asynchronous module.

The processor 10, upon receiving a suitable command from the master device in synchronous communications identifying that synchronous communications are to be temporarily stopped, can begin communicating using the asynchronous transceiver circuit 12. The asynchronous protocol used allows for the devices to transmit larger data packets using a clock speed that is either fixed or within a predetermined limit. It has been found that data transfer rates of at least 70 kbs are possible and in some cases, rates may exceed 128 kbs. This medium bandwidth data rate is much greater than 1 kbs that is available in the conventionally implemented synchronous transmission, and it is sufficient for transferring large blocks of data, such as firmware upgrades.

The data rate of 60 kbs or greater also allows the network to be used medium bandwidth applications, such as audio, transmission of still images, and low resolution or low frame rate video. In a security system network, network devices can include interfaces for microphones, loud speakers, still digital cameras and video cameras for monitoring purposes, such as webcams or video compression modules connected to CCTV cameras, as well as display devices for decompressing or decoding and displaying the video transmitted on the network. These devices, allow for a control panel or other monitoring station to monitor a building access security, and/or allow for remote monitoring of protected premises. By providing the ability to connect a large number of nodes, a security system for an industrial installation can be implemented using a single mesh network bus as described above.

Asynchronous communications between the devices may continue on the transmission line until the master device transmits a command to the other devices on the network using the asynchronous protocol to the effect that transmission using the asynchronous protocol should stop, and thus return to using the synchronous protocol. The devices thus switch from using circuits 11 and 12 and their associated I/o pins on the processor 10 as a function of the control commands issued by processor 10.

It will be appreciated that the switching back and forth from synchronous to asynchronous communications does not need to follow command data. The master device could allow the slave devices to return to asynchronous communication by merely stopping its transmission of the clock signal, and after a few cycles of the absence of the clock signal, the devices may interpret this silence as a command to return to asynchronous communications. Likewise, the master device could wait for quiet on the network during asynchronous communications before resuming synchronous communications.

While an asynchronous data command from the master device is preferred as the trigger to switch from asynchronous to synchronous communications, it will be appreciated that the master device could place a signal state on the transmission line that would be recognized by the other devices as a trigger to stop asynchronous communications so that synchronous communications may return.

It will also be appreciated that some network devices may operate using only asynchronous communications, and thus the synchronous transceiver circuit may be replaced by circuitry that detects the states associated with the master device commands relating to switching of communication modes without necessarily decoding data bits from the transmission line in synchronous mode. Alternatively, the asynchronous communication can ignore invalid asynchronous packets, and thus the synchronous communication will be ignored. This can be useful for devices whose objective is to communicate with a network device having the dual protocol communication or for devices that can benefit from using the same transmission line and only communicate with similar asynchronous devices on the network.

In the following description, the collision control implemented during asynchronous transmission is described. Collision control allows in asynchronous communication a higher effective throughput of data by reducing collision. The asynchronous communications according to the embodiment described uses carrier sense multiple access (CSMA) with collision avoidance. According to this class of protocols, a station wishing to transmit has to first listen to the channel for a predetermined amount of time so as to check for any activity on the channel. If the channel is sensed “idle” then the station is permitted to transmit. If the channel is sensed as “busy” the station has to defer its transmission. It has been measured that reduction of collisions using the embodiment illustrated can avoid a loss of effective throughput on the network of up to 70% in comparison to CSMA-CA. The CSMA-CA protocol allows for collision detection at the word or byte level. This means that once a device decides that the line is free to use, it transmits a group of bits and detects the bits during its transmission. If what it sent is not what it receives, then there was collision. The protocol may also determine that a collision took place if an acknowledge message is not received from the destination in response to the sent message. The device then stops sending more words or bytes, and follows a waiting scheme before trying again. Should it succeed in sending a whole word through the next time, then the device will continue to transmit data until it has no more data to send or otherwise the protocol dictates that it has reached its maximum. If it detects that the line is busy before beginning to send its word, then the device must wait for the line to be free again. If it begins sending its word and detects collision again, then a further waiting period is involved.

When there are many devices on the network, e.g. more than 20 active devices, there is a need for many devices to communicate simultaneously, and the conventional collision detection and resolution protocol under RS-485 wastes a great deal of time before the congestion is resolved. When traffic is calm, the ability for a device to quickly get its data through is efficient. When collision becomes common, so do the delays in transmission.

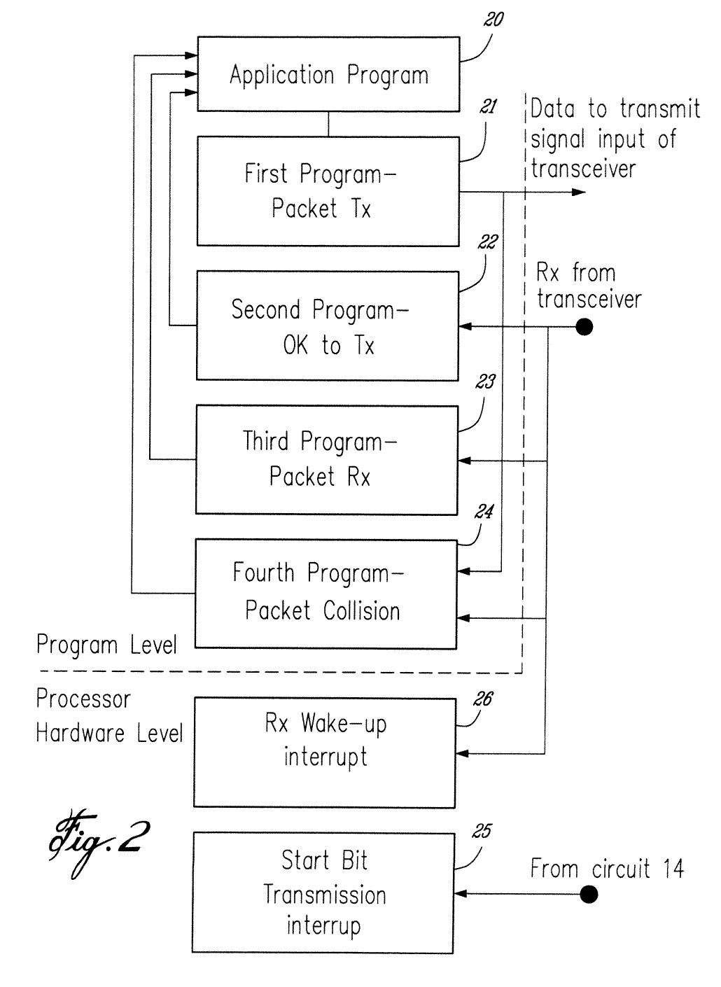

In the embodiment illustrated in FIGS. 1 and 2, the terminal device comprises a microprocessor 10 running program code defining the operation of the device. In the embodiment of FIG. 2, the processor 10 operates to execute the program code in a sequential instruction, single tasking manner. Within this program code are modules for handling data network communications in accordance with a protocol using a simple packet structure of 7 to 10 bits (one byte/word), including typically, a start bit and one or two stop bits. The device may transmit multiple word bytes or packets in a row in accordance with protocol rules.

The device may comprise a first program 21 for handling the transmission of a packet. This program arranges the start and stop bits, along with the encoding of the payload data into a packet, and sends the bits to the transceiver in the correctly timed sequence. In the chosen protocol, a packet is about 7 to 10 bits long, although a greater size is also practical. A second program 22 is used to listen to the network medium via the transceiver to determine if the device may transmit a packet. This program waits until a current packet is finished transmitting, and then, if there is no transmission on the medium, it is determined that it is okay to transmit a packet.

A third program 23 is used to receive packets. This program detects via the transceiver all received bits, determines start and stop bits, and decodes packets. A fourth program 24 determines collision. In the chosen protocol, collision can be detected by receiving packets even when transmitting, and checking if the received packet is indeed the same as the transmit data (the collision detection is described in detail below). If not, another terminal transmitted at the same time and corrupted the data on the network, and retransmission is required. Program 24 is called by program 21 during transmission to check if what is received is what is being transmitted. The collision detection result may be read by program 20 or alternatively by program 21. The network communications programs are commanded by an application program 20 to perform its required communications tasks.

In the embodiment of FIG. 2, collision detection is performed in accordance with the protocol to provide confirmation that no collision took place, however, in addition to collision detection, collision avoidance is performed. As shown in FIGS. 1 and 2, the processor 10 is arranged to use an input pin for a collision interrupt 25 triggered by a signal that is simply the Rx, or received signal from the network transceiver 12. A blocking switch 14 is arranged to prevent the Rx signal from causing an interrupt once the start bit is sent from the processor 10 to the transceiver 12. While in the preferred embodiment, the transceiver 12 is external to the processor 10, it may alternatively be internal to the processor 10. The first program 21 establishes the interrupt 25 within the processor when the first program is executed. The interrupt causes the first program to stop sending bits of the packet, and then to recover as will be described in greater detail below. The first program then sends the start bit of the packet. When the first program determines that the start bit has been sent, it then cancels the interruption of transmission, since at this point, if no interrupt has been previously triggered, there has been no collision.

It will be appreciated that if program 21 were to attempt to read the Rx value just before sending the start bit of a packet to see if there was going to be collision, program 21 cannot work effectively to prevent collision because of the time delay for processor 10 to implement such instructions. Furthermore, processor 10 may be responsive to interrupts from other input circuits within the terminal device, such as sensors, that will require the processor to execute, albeit briefly, other programs before returning to program 21. This operation is necessary for processor 10 to response to its input devices, however, it makes it even more difficult to attempt to detect start bit collision at the program level. In a multitasking operating system, program 21 may also be delayed in its execution by the processor providing CPU time to other tasks. At the hardware level, however, the response time of circuits 12 and 14, as well as the interrupt 25, are effective to prevent collision of competing start bits.

The use of circuit 14 in conjunction with interrupt 25 is preferred since it prevents the interrupt from being automatically generated with every start bit sent by the terminal when its echo is received back from the network. However, circuit 14 is not essential for preventing this interrupt from occurring. Processor 10 can set the interrupt 25 in a first step, and then in a second step send the start bit. The interrupt will occur no matter whether there is a collision or merely an echo. When the interrupt happens, the processor 10 can look at a register in the processor that indicates the address of the last instruction executed by the processor when the interrupt occurred. If this last address was not the start bit send instruction in program 21, then recovery follows the collision option. If this last address was the start bit send instruction, then the recovery involves disabling the interrupt and continuing with the packet sending.

In this case, a later collision, i.e. a collision with another device that sent its start bit at exactly the same time or whose start bit was not detected, would not be detected and the whole packet transmission would continue with collision. It will be appreciated that the chances of two devices sending a start bit at the same time is small. Circuit 14, when included in the device, serves to prevent detection of collision in response to devices own transmission during all bits of the packet.

In addition to checking the last executed instruction address to confirm whether the interrupt was triggered before or after sending the start bit, the processor 10 can also check the last process enabled or a flag (bit in a register) that is set with initiation of transmission.

If a collision is detected at the time of sending the start bit, program 21 preferably recovers by jumping to program 23 to receive the packet that was about to collide with the outgoing packet. Once this packet is received, it is possible to allow program 20 to progress knowing there was a collision and a new packet received from the network. However, preferably, the received packet is simply stored in a received packet buffer, and program 21 is caused to continue to attempt to retransmit. Such retransmission attempt can be delayed slightly such that when a terminal is entitled to send multiple packets successively, interrupt 25 will cause program 23 to receive all packets before program 21 successfully gets out its packet.

Alternatively, recovery may involve timing the length of one packet and then immediately attempting to send the start bit again. In a single tasking processor system, waiting within program 21 will result in the received packet being missed since the processor 10 will only receive a packet when program 23 is executed. The application program 20 need not know about the start bit collision and retransmission, and program 24 does not generate any indication of collision. It is of course possible to have the interrupt recovery simply stop packet transmission and trigger an indication of packet collision from program 24, and let the program 20 decide to retransmit when program 22 determines that it is time. While this avoids packet collision, the time to retransmit is lengthened considerably.

It will also be appreciated that start bit collision can be detected and prevented differently than the preferred embodiment, namely without using an interrupt. For example, the transmit data input to the transceiver could be blocked by suitable circuitry if, on the leading edge of the start bit, there is signal on the transceiver's Rx signal output. Program 21 then continues to send the packet data, but with the blocking, collision on the network is avoided. A timer in the alternative blocking circuitry could cause this blocking to be for at least the duration of a packet, or at least until program 24 can determine collision and allow for program 20 to command program 21 to stop transmission. In this way, an interrupt 25 is not required since the transmission is merely “silenced” at the hardware level. While an interrupt allows for intelligent recovery and retransmission, collision is avoided nonetheless by this alternative.

By avoiding collision in accordance with the present invention, throughput on a network of terminal devices is greatly enhanced under circumstances where multiple terminal devices are attempting to transmit data essentially at the same time. This allows for applications in which minimal delay and/or higher throughput is required using terminals that are based on a network transceiver combined with a relatively low speed processor having program code for handling communications in accordance with a protocol.

The invention also provides for an interrupt 26 to be set, namely an interrupt triggered by the receipt of a packet for activating program 23. In the preferred embodiment, this interrupt is established prior to putting the processor into a sleep mode in which processing of program instructions stops, such that the processor 10 consumes minimal power while waiting for a packet to be received. Sleep modes are common in many processors. In some sleep modes, volatile memory is powered, while the CPU shuts down and stops executing further instructions until an interrupt wakes up the processor. Once the start bit is detected, interrupt 26 is triggered and the interrupt causes the processor to exit its sleep mode, remove the interrupt 26, begin executing program 23 to receive the incoming packet, and then control is returned to a part of program 20 that will read the packet detected and decoded by program 23. This is achieved without missing the incoming packet. Program 20 will determine the next suitable time to establish interrupt 26 and re-enter sleep mode.

The invention may also be used to measure the width of the shortest bit in a received packet and thus determine the baud rate on the network. Program 21 may be adapted to automatically adjust the baud rate of the transmission from the terminal device to the baud rate measured from the network. This measurement may be an average, or the specific baud rate used by leader or master terminal device on the network. The measurement may be performed by program 23, and its reliability is ensured when interrupt 26 immediately activates its operation. The baud rate selection can be from a pre-defined table of different baud rates and/or be dynamically computed to match the measured baud rate.

1. A local network for interconnecting building control and/or security system devices comprising:
a transmission cable interconnecting a large number of network devices in a multi-drop, mesh topology without end-of-line terminations; and
a large number of network devices connected to and communicating asynchronously on a transmission line of said cable using a packet size containing at least 7 data bits and pure CSMA,
wherein a combination of said number of network devices, a quality of said transmission line and said packet size results in a nominal effective data transmission throughput on the network of two or more times greater than said nominal effective data transmission throughput on the network under conditions that collision detection is done after transmission of a first full packet by said devices on the network.

2. The network as defined in claim 1, wherein surge protection circuitry is connected to most or all of said network devices, said circuitry having a capacitance less than 250 pF for each said network device.

3. The network as defined in claim 2, wherein said capacitance is less than 60 pF.

4. The network as defined in claim 1, wherein said cable is unshielded or untwisted, a physical layer signaling on said transmission line being differential or balanced.

5. The network as defined in claim 1, wherein most or all of said network devices each comprise a microcontroller for handling protocol layer communications on said network, said microcontroller having an interrupt connected to a received signal from said network and being configured to implement collision detection and avoidance at least up to transmission of a start bit.

6. The network as defined in claim 5, wherein said microcontroller also performs data processing for operation of said network devices.

7. The network as defined in claim 1, wherein said nominal effective data transmission throughput on the network is greater than 60 kbs.

8. The network as defined in claim 7, wherein said network is used to stream compressed video.

9. The network as defined in claim 7, wherein said network is used to stream audio.

10. The network as defined in claim 1, wherein the number of network devices is greater than 64.

11. The network as defined in claim 1, wherein at least some of said network devices comprise:
a master/slave protocol communications module connected to a network connection; and
a carrier sense multiple access protocol module connected to said network connection;
wherein said network devices are adapted to switch between said master/slave protocol communications module and said carrier sense multiple access protocol module for transmitting data on said network.

12. The network as defined in claim 11, wherein said master/slave protocol is used by a security system control panel acting as a master and a number of said network devices performing intrusion detection functions acting as slaves.

13. The network as defined in claim 12, wherein some of said network devices perform building control functions and communicate asynchronously using said carrier sense multiple access protocol module.

14. The network as defined in claim 13, wherein most or all of said network devices each comprise a microcontroller for handling protocol layer communications on said network, said microcontroller having an interrupt connected to a received signal from said network and being configured to implement collision detection and avoidance at least up to transmission of a start bit.

15. The network as defined in claim 14, wherein said microcontroller also performs data processing for operation of said network devices.

16. The network as defined in claim 4, wherein said cable has a power bus and a pair of data wires, said bus and data wires operating at a nominal voltage of 12V.

17. A dual protocol network device comprising:
a master/slave protocol communications module connected to a network connection;
a carrier sense multiple access protocol module connected to said network connection;
a microcontroller adapted to switch between said master/slave protocol communications module and said carrier sense multiple access protocol module for transmitting data on said network.

18. A local network pure CSMA device for building control and/or security systems comprising:
a microcontroller for handling protocol layer communications on said network, said microcontroller having an interrupt connected to a received signal from said network and being configured to implement collision detection and avoidance at least up to transmission of a start bit.

19. The network device as defined in claim 18, wherein said microcontroller also performs data processing for building control and/or security system functions of said network device.
